(19) United States
(12) Patent Application Publication
(10) Pub. No.: US 2024/0030423 A1
(43) Pub. Date: Jan. 25, 2024

(54) A POSITIVE ELECTRODE ACTIVE MATERIAL FOR RECHARGEABLE LITHIUM-ION BATTERIES

(71) Applicant: UMICORE, Brussels (BE)

(72) Inventors: Jens Martin PAULSEN, Chungcheongnam-do (KR); Shinichi KUMAKURA, Olen (BE); Liang ZHU, Brussels (BE); JiHye KIM, Chungcheongnam-do (KR); JiHoon KANG, Chungcheongnam-do (KR); HyeJeong YANG, Chungcheongnam-do (KR); YuRi LEE, Chungcheongnam-do (KR)

(21) Appl. No.: 18/265,630

(22) PCT Filed: Dec. 17, 2021
(86) PCT No.: PCT/EP2021/086400

§ 371 Date: Jun. 6, 2023

(30) Foreign Application Priority Data
Dec. 18, 2020 (EP) 20215514.9

(51) Int. Cl. H01M 4/40; H01M 4/485; H01M 10/0525

(52) U.S. Cl. CPC H01M 4/405; H01M 4/485; H01M 10/0525; H01M 2004/028

(57) ABSTRACT

A positive electrode active material for lithium-ion liquid electrolyte rechargeable batteries, whereby the positive electrode active material is a powder which comprises Li, M′, and O, wherein M′ consists of Co in a content x superior or equal to 2.0 mol % and inferior or equal to 35.0 mol %, Mn in a content y superior or equal to 0 mol % and inferior or equal to 35.0 mol %, A in a content m superior or equal to 0 mol % and inferior or equal to 5 mol %, whereby A comprises at least one element of the group consisting of: Al, Ba, B, Mg, Nb, Sr, Ti, W, S, Ca, Cr, Zn, V, Y, Si, and Zr, Ni in a content of 100-x-y-m mol %, a first compound which comprises Li2WO4 and a second compound which comprises WO3, whereby the powder is a single-crystalline powder, whereby the positive electrode active material comprises Li in a molar ratio of Li/(Co+Mn+Ni+A) of at least 0.9 and at most 1.1.

### TECHNICAL FIELD

The present invention relates to a positive electrode active material for lithium-ion liquid electrolyte rechargeable batteries. More specifically, the invention relates to particulate positive electrode active materials comprising tungsten oxides.

### BACKGROUND

This invention relates to a single-crystalline positive electrode active material powder for lithium-ion rechargeable batteries (LIBs), comprising a first compound which comprise lithium tungsten oxide, and a second compound which comprises tungsten oxide.

Such positive electrode active materials are already known, for example from KR 2019/0078991. The document KR 2019/0078991 discloses positive electrode active material powder comprises a mixture of lithium transition metal oxide and lithium tungsten oxide compounds. However, the positive electrode active material according to KR 2019/0078991 has low initial discharge capacity (DQ1) and high irreversible capacity (IRRQ).

It is therefore an object of the present invention to provide a positive electrode active material which has improved electrochemical properties as indicated, for example, by the DQ1 value and IRRQ value in an electrochemical cell as determined by the analytical method of the present invention.

### SUMMARY OF THE INVENTION

This objective is achieved by providing a positive electrode active material for lithium-ion rechargeable batteries, whereby the positive electrode active material is a powder which comprises Li, M′, and O, wherein M′ consists of:
Co in a content x superior or equal to 2.0 mol % and inferior or equal to 35.0 mol %, relative to M′,
Mn in a content y superior or equal to 0 mol % and inferior or equal to 35.0 mol %, relative to M′,
A in a content m superior or equal to 0 mol % and inferior or equal to 5 mol %, relative to M′, whereby A comprises at least one element of the group consisting of: Al, Ba, B, Mg, Nb, Sr, Ti, W, S, Ca, Cr, Zn, V, Y, Si, and Zr,
Ni in a content of 100-x-y-m mol %,
i. a first compound which comprises Li₂WO₄
ii. and a second compound which comprises WO₃,
whereby the powder is a single-crystalline powder,
whereby the positive electrode active material comprises Li in a molar ratio of Li/(Co+Mn+Ni+A) of at least 0.900 and at most 1.100.

It is indeed observed that a higher DQ1 and a lower IRRQ is achieved using a positive electrode active material according to the present invention, as illustrated by examples and supported by the results provided in Table 2.

Further, the present invention provides an electrochemical cell comprising a positive electrode active material according to the first aspect of the invention; a lithium ion rechargeable battery comprising a liquid electrolyte and a positive electrode active material according to the first aspect of the invention; and a use of a positive electrode active material according to the first aspect of the invention in a battery of either one of a portable computer, a tablet, a mobile phone, an electrically powered vehicle and an energy storage system.

### BRIEF DESCRIPTION OF THE FIGURES

By means of further guidance, a figure is included to better appreciate the teaching of the present invention. Said figure is intended to assist the description of the invention and is nowhere intended as a limitation of the presently disclosed invention.

FIG. 1 shows an X-ray diffractogram of a positive electrode active material powder according to EX1.7 comprising Li₂WO₄ and WO₃ compounds.

FIG. 2 shows the X-ray diffractograms of CEX2, EX1.4, and CEX3.3.

In these figures the horizontal axis shows the diffraction angle 2θ in degrees, the vertical axis shows the signal intensity on a logarithmic scale.

### DETAILED DESCRIPTION OF THE INVENTION

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention. As used herein, the following terms have the following meanings:

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far, such variations are appropriate to perform in the disclosed invention. However, it is to be understood that the value to which the modifier “about” refers is itself also specifically disclosed.

The recitation of numerical ranges by endpoints includes all numbers and fractions subsumed within that range, as well as the recited endpoints. All percentages are to be understood as percentage by weight, abbreviated as “wt. %” unless otherwise defined or unless a different meaning is obvious to the person skilled in the art from its use and in the context wherein it is used.

The term “ppm” is as used in this document means parts per million on a mass basis.

Positive Electrode Active Material

In a first aspect, the present invention provides a positive electrode active material, whereby the positive electrode active material is a powder which comprises Li, M′, and O, wherein M′ consists of:
Co in a content x superior or equal to 2.0 mol % and inferior or equal to 35.0 mol %, relative to M′,
Mn in a content y superior or equal to 0 mol % and inferior or equal to 35.0 mol %, relative to M′,
A in a content m superior or equal to 0 mol % and inferior or equal to 5 mol %, relative to M′, whereby A comprises at least one element of the group consisting of: Al, Ba, B, Mg, Nb, Sr, Ti, W, S, Ca, Cr, Zn, V, Y, Si, and Zr,
Ni in a content of 100-x-y-m mol %, relative to M′,
i. a first compound which comprises Li₂WO₄
ii. and a second compound which comprises WO₃,
whereby the powder is a single-crystalline powder,
whereby the positive electrode active material comprises Li in a molar ratio of Li/(Co+Mn+Ni+A) of at least 0.900 and at most 1.100.

A single-crystalline powder is considered to be a powder in which 80% or more of the particles in a field of view of at least 45 μm×at least 60 μm (i.e. of at least 2700 μm²), preferably of: at least 100 μm×100 μm (i.e. of at least 10,000 μm²) in a SEM image have a single-crystalline morphology.

A particle is considered to have single-crystalline morphology if it consists of only one grain, or a very low number of a most five, constituent grains, as observed by SEM or TEM. Contrary, a particle is considered to have a polycrystalline morphology if it consists of at least six constituent grains, as observed by SEM or TEM.

For the determination of single-crystalline morphology of particles, grains which have a largest linear dimension as observed by SEM which is smaller than 20% of the median particle size D50 of the powder as determined by laser diffraction are ignored. This avoids that particles which are in essence single-crystalline, but which may have deposited on them several very small other grains, are inadvertently considered as not having a single-crystalline morphology.

The inventors have found that a positive electrode active material for lithium-ion rechargeable batteries according to the invention indeed allows a higher DQ1 and lower IRRQ. This is illustrated by examples and the results provided in the Table 2.

Preferably, the present invention provides a positive electrode active material according to the first aspect of the invention, wherein the total content of tungsten is at least 0.20 wt. % and/or at most 2.50 wt. % with respect to the total weight of said positive electrode active material, as determined by ICP-OES analysis, whereby ICP-OES means Inductively coupled plasma—optical emission spectrometry. Preferably, said weight ratio is between 0.25 wt. % and 2.00 wt. % and more preferably, said weight ratio is equal to 0.30, 0.50, 1.00, 1.50, 2.00 wt. % or any value there in between.

A positive active material is defined as a material which is electrochemically active in a positive electrode. By active material, it must be understood a material capable to capture and release Li ions when subjected to a voltage change over a predetermined period of time.

The content of each element can be determined by known analysis methods, such as ICP-OES (Inductively coupled plasma—optical emission spectrometry).

Preferably, Ni content 100-x-y-m in the positive electrode active material is 60 mol % and more preferably 65 mol %, relative to M′.

Preferably, Ni content 100-x-y-m in the positive electrode active material is 95 mol % and more preferably 90 mol %, relative to M′.

Preferably, Mn content y in the positive electrode active material is 0 mol % and more preferably 5 mol %, relative to M′.

Preferably, Mn content y in the positive electrode active material is 35 mol % and more preferably 30 mol %, relative to M′.

Preferably, Co content x in the positive electrode active material is 2 mol % and more preferably 5 mol %, relative to M′.

Preferably, Co content x in the positive electrode active material is 35 mol % and more preferably 30 mol %, relative to M′.

Preferably, A content m in the positive electrode active material is superior or equal to 0.01 mol %, relative to M′.

Preferably, A content m in the positive electrode active material is inferior or equal to 2.0 mol %, relative to M′.

Preferably, the positive electrode active material has a median particle size D50 of between 2 μm and 7 μm, as determined by laser diffraction particle size analysis.

Preferable, the positive electrode active material size D99 is at least 5 μm and at most 25 μm and more preferably is at least 7 μm and at most 20 μm, as determined by laser diffraction particle size analysis.

D50 and D99 each are defined herein as the particle size at 50% and 99% of the cumulative volume % distributions, respectively, of the positive electrode active material powder which may be determined by laser diffraction particle size analysis.

First Compound and Second Compound

Preferably, the present invention provides a positive electrode active material according to the first aspect of the invention, wherein the first compound comprises Li₂WO₄ and belongs to the R-3 space group and a second compound comprises WO₃ and belongs to the P21/n space group, as determined by X-Ray diffraction analysis.

Preferably, the present invention provides a positive electrode active material according to the first aspect of the invention, wherein the total content of tungsten is between 0.20 wt. % and 2.50 wt. % with respect to the total weight of said positive electrode active material, as determined by ICP-OES analysis. Preferably, said weight ratio is between 0.25 wt. % and 2.00 wt. % and more preferably, said weight ratio is equal to 0.50, 1.00, 1.50, 2.00 wt. % or any value there in between.

In a second aspect, the present invention provides a battery cell comprising a positive electrode active material according to the first aspect of the invention.

In a third aspect, the present invention provides a use of a positive electrode active material according to the first aspect of the invention in a battery of either one of a portable computer, a tablet, a mobile phone, an electrically powered vehicle, and an energy storage system.

Lithium Transition Metal Oxide Third Compound

Preferably, the present invention provides a positive electrode active material according to the first aspect of the invention, whereby the positive electrode active material comprises a third compound which belongs to the R-3m space group as determined by X-Ray diffraction analysis.

Preferably, said third compound is a lithium transition metal oxide i.e. a Li-M′-oxide as defined herein above. The lithium transition metal oxide is identified by X-Ray diffraction analysis. According to “Journal of Power Sources (2000), 90, 76-81”, the lithium transition metal oxide has a crystal structure which belongs to the R-3m space group.

Electrochemical Cell

In a second aspect, the present invention provides an electrochemical cell comprising a positive electrode active material according to the first aspect of the invention; a lithium ion rechargeable battery comprising a liquid electrolyte and a positive electrode active material according to the first aspect of the invention; and a use of a positive electrode active material according to the first aspect of the invention in a battery of either one of a portable computer, a tablet, a mobile phone, an electrically powered vehicle and an energy storage system.

Method for Preparing a Positive Electrode Active Material

Preferably, the present invention provides a method for preparing a positive electrode active material according to the first aspect of the invention, as described herein above, wherein the method comprises the following steps of:
mixing a single-crystalline lithium transition metal oxide powder with a W containing compound so as to obtain a mixture,
heating the mixture in an oxidizing atmosphere at a temperature of between 250° C. and 450° C. so as to obtain the positive electrode active material.

Preferably, the W containing compound is WO₃.

Preferably, the amount of W used is in said process is between 0.20 wt. % and 2.50 wt. % with respect to the total weight of said positive electrode active material, as determined by ICP-OES analysis.

Preferably, the second mixture is heated at a temperature of between 300° C. and 400° C., and more preferably at a temperature of between 325° C. and 375° C.

Preferably, the heated powder and/or positive electrode material is further processed, for example by crushing and/or sieving.

Optionally, the lithium transition metal oxide comprises A, wherein A comprises at least one element selected from the group consisting of: Al, Ba, B, Mg, Nb, Sr, Ti, W, S, Ca, Cr, Zn, V, Y, Si, and Zr.

### EXAMPLES

The following examples are intended to further clarify the present invention and are nowhere intended to limit the scope of the present invention.

### 1. DESCRIPTION OF ANALYSIS METHOD

1.1. Inductively Coupled Plasma

The composition of a positive electrode active material powder is measured by the inductively coupled plasma (ICP) method using an Agilent 720 ICP-OES (Agilent Technologies, https://www.agilent.com/cs/library/brochures/5990-6497EN%20720-725_ICP-OES_LR.pdf). 1 gram of powder sample is dissolved into 50 mL of high purity hydrochloric acid (at least 37 wt. % of HCl with respect to the total weight of solution) in an Erlenmeyer flask. The flask is covered by a watch glass and heated on a hot plate at 380° C. until the powder is completely dissolved. After being cooled to room temperature, the solution from the Erlenmeyer flask is poured into a first 250 mL volumetric flask. Afterwards, the first volumetric flask is filled with deionized water up to the 250 mL mark, followed by a complete homogenization process (1^{st} dilution). An appropriate amount of the solution from the first volumetric flask is taken out by a pipette and transferred into a second 250 mL volumetric flask for the 2^{nd} dilution, where the second volumetric flask is filled with an internal standard element and 10% hydrochloric acid up to the 250 mL mark and then homogenized. Finally, this solution is used for ICP-OES measurement.

1.2. Particle Size Distribution

The particle size distribution (PSD) of the positive electrode active material powder is measured by laser diffraction particle size analysis using a Malvern Mastersizer 3000 with a Hydro MV wet dispersion accessory (https://www.malvernpanalytical.com/en/products/product-range/mastersizer-range/mastersizer-3000#overview) after having dispersed each of the powder samples in an aqueous medium. In order to improve the dispersion of the powder, sufficient ultrasonic irradiation and stirring is applied, and an appropriate surfactant is introduced. D50 and D99 each are defined as the particle size at 50% and 99% of the cumulative volume % distributions obtained from the Malvern Mastersizer 3000 with Hydro MV measurements.

1.3. X-Ray Diffraction

The X-ray diffraction pattern of the positive electrode active material is collected with a Rigaku X-Ray Diffractometer D/max2000 (Rigaku, Du, Y., et al. (2012). A general method for the large-scale synthesis of uniform ultrathin metal sulphide nanocrystals. Nature Communications, 3(1)) using a Cu Kα radiation source (40 kV, 40 mA) emitting at a wavelength of 1.5418 Å. The instrument configuration is set at: a 1° Soller slit (SS), a 10 mm divergent height limiting slit (DHLS), a 1° divergence slit (DS) and a 0.3 mm reception slit (RS). The diameter of the goniometer is 185 mm. For the XRD, diffraction patterns are obtained in the range of 15-70° (20) with a scan speed of 1° per min and a step-size of 0.02° per scan.

1.4. Coin Cell Test

1.4.1. Coin Cell Preparation

For the preparation of a positive electrode, a slurry that contains a positive electrode active material powder, conductor (Super P, Timcal), binder (KF #9305, Kureha)—with a formulation of 90:5:5 by weight—in a solvent (NMP, Mitsubishi) is prepared by a high-speed homogenizer. The homogenized slurry is spread on one side of an aluminum foil using a doctor blade coater with a 230 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1 M LiPF₆ in EC/DMC (1:2) is used as electrolyte and is dropped between separator and electrodes. Then, the coin cell is completely sealed to prevent leakage of the electrolyte.

1.4.2. Testing Method

The testing method is a conventional “constant cut-off voltage” test. The conventional coin cell test in the present invention follows the schedule shown in Table 1. Each cell is cycled at 25° C. using a Toscat-3100 computer-controlled galvanostatic cycling station (from Toyo). The schedule uses a 1C current definition of 220 mA/g. The initial charge capacity (CQ1) and discharge capacity (DQ1) are measured in constant current mode (CC) at C rate of 0.1C in the 4.3 V to 3.0 V/Li metal window range.

The irreversible capacity IRRQ is expressed in % as follows:

IRRQ (%)=100*(CQ1−DQ1)/CQ1

TABLE 1
Cycling schedule for coin cell testing method

| Charge | | | | Discharge | | | |
|---|---|---|---|---|---|---|---|
| C | End | Rest | V/Li metal | C | End | Rest | V/Li metal |
| Rate | current | (min) | (V) | Rate | current | (min) | (V) |
| 0.1 | — | 30 | 4.3 | 0.1 | — | 30 | 3.0 |

### 2. EXAMPLES AND COMPARATIVE EXAMPLES

### Comparative Example 1

A single-crystalline positive electrode active material labelled as CEX1.1 is prepared according to the following steps:

Step 1) Transition metal oxidized hydroxide precursor preparation: A nickel-based transition metal oxidized hydroxide powder (TMH1) having a metal composition of Ni_{0.86}Mn_{0.07}Co_{0.07} is prepared by a co-precipitation process in a large-scale continuous stirred tank reactor (CSTR) with mixed nickel manganese cobalt sulfates, sodium hydroxide, and ammonia.

Step 2) Heating: the TMH1 prepared from Step 1) is heated at 400° C. for 7 hours in an oxidizing atmosphere to obtain a heated powder.

Step 3) First mixing: the heated powder prepared from Step 2) is mixed with LiOH in an industrial blender so as to obtain a first mixture having a lithium to metal ratio of 0.96.

Step 4) First firing: The first mixture from Step 3) is fired at 890° C. for 11 hours in an oxidizing atmosphere so as to obtain a first fired powder.

Step 5) Wet bead milling: The first fired powder from Step 4) is bead milled with solid to water weight ratio of 6:4 for 20 minutes, followed by filtering, drying, and sieving process so as to obtain a milled powder.

Step 6) Second mixing: the milled powder from Step 5) is mixed with LiOH in an industrial blender so as to obtain a second mixture having a lithium to metal ratio of 0.99.

Step 7) Second firing: the second mixture from Step 6) is fired at 760° C. for 10 hours in a oxidizing atmosphere, followed by crushing and sieving process so as to obtain a second fired powder labelled as CEX1.1.

### Comparative Example 2

A single-crystalline positive electrode active material labelled as CEX2 is prepared according to the following steps:

Step 1) Transition metal oxidized hydroxide precursor preparation: A nickel-based transition metal oxidized hydroxide powder (TMH2) having a metal composition of Ni_{0.86}Mn_{0.07}Co_{0.07} is prepared by a co-precipitation process in a large-scale continuous stirred tank reactor (CSTR) with mixed nickel manganese cobalt sulfates, sodium hydroxide, and ammonia.

Step 2) Heating: the TMH2 prepared from Step 1) is heated at 400° C. for 7 hours in an oxidizing atmosphere to obtain a heated powder.

Step 3) First mixing: the heated powder prepared from Step 2) is mixed with LiOH in an industrial blender so as to obtain a first mixture having a lithium to metal ratio of 0.96.

Step 4) First firing: The first mixture from Step 3) is fired at 890° C. for 11 hours in an oxidizing atmosphere so as to obtain a first fired powder.

Step 5) Wet bead milling: The first fired powder from Step 4) is bead milled in a solution containing 0.5 mol % Co with respect to the total molar contents of Ni, Mn, and Co in the first fired powder followed by dying and sieving process so as to obtain a milled powder. The bead milling solid to solution weight ratio is 6:4 and is conducted for 20 minutes.

Step 6) Second mixing: the milled powder obtained from Step 5) is mixed in an industrial blender with 1.5 mol % Co from Co₃O₄ and 7.5 mol % Li from LiOH, each with respect to the total molar contents of Ni, Mn, and Co in the milled powder so as to obtain a second mixture.

Step 7) Second firing: The second mixture from Step 6) is fired at 760° C. for 10 hours in an oxidizing atmosphere followed by crushing and sieving process so as to obtain a second fired powder labelled as CEX2.

### Example 1

EX1.0 is prepared according to the following process:

Step 1) CEX1.1 is mixed with WO₃ powder to obtain a mixture contains about 0.45 wt. % of tungsten with respect to the total weight of the mixture.

Step 2) Heating the mixture obtained from Step 1) in a furnace under the flow of an oxidizing atmosphere at 350° C. for 10 hours.

Step 3) Crushing and sieving the heated product from Step 2) so as to obtain a powder labelled as EX1.0.

EX1.1 is prepared according to the following process:

Step 1) CEX2 is mixed with WO₃ powder to obtain a mixture contains about 0.24 wt. % of tungsten with respect to the total weight of the mixture.

Step 2) Heating the mixture obtained from Step 1) in a furnace under the flow of an oxidizing atmosphere at 350° C. for 10 hours.

Step 3) Crushing and sieving the heated product from Step 2) so as to obtain a powder labelled as EX1.1.

EX1.2, EX1.3, EX1.4, EX1.5, EX1.6, and EX1.7 are prepared according to the same method as EX1.1 except that in the Step 1) CEX2 is mixed with WO₃ powder so as to obtain a mixture contains about 0.36, 0.43, 0.45, 0.48, 0.75, and 1.50 wt. % of tungsten with respect to the total weight of the mixture, respectively.

EX1.8 and EX1.9 are prepared according to the same method as EX1.1 except that in the Step 1) CEX2 is mixed with WO₃ powder so as to obtain a mixture contains about 0.36 wt. % of tungsten with respect to the total weight of the mixture, and the heating temperature in the Step 2) are 300° C. and 400° C., respectively.

### Comparative Example 3

CEX3.1 is prepared according to the same method as EX1.1 except that in the Step 1) CEX2 is mixed with WO₃ powder so as to obtain a mixture contains about 3.00 wt. % of tungsten with respect to the total weight of the mixture.

CEX3.2 is prepared according to the same method as EX1.1 except that in the Step 1) CEX2 is mixed with WO₃ powder so as to obtain a mixture contains about 0.36 wt. % of tungsten with respect to the total weight of the mixture, and no heating is applied in the Step 2).

CEX3.3 is prepared according to the same method as EX1.1 except that in the Step 1) CEX2 is mixed with WO₃ powder so as to obtain a mixture contains about 0.45 wt. % of tungsten with respect to the total weight of the mixture, and the heating temperature applied in the Step 2) is 550° C.

The particle size distributions of the products from CEX1.1, CEX2, and EX1.3 were determined by a Malvern Mastersizer 3000, as described in section 1.2 above. These products all have a median particle size D50 of between 3.8 and 4.5 μm and D99 between 9.6 μm to 11.1 μm.

### Comparative Example 4

A polycrystalline positive electrode active material labelled as CEX4.1 is prepared according to the following steps:

Step 1) Transition metal oxidized hydroxide precursor preparation: two transition metal-based oxidized hydroxide precursors, each labelled as TMH3 and TMH4, were prepared by a co-precipitation process in a large-scale continuous stirred tank reactor (CSTR) with mixed nickel-manganese-cobalt sulfates, sodium hydroxide, and ammonia. TMH3 D50 is around 10 μm and TMH4 D50 is around 4 μm, both with metal composition of Ni_{0.65}Mn_{0.2}0Co_{0.15}.

Step 2) First mixing: TMH3 and TMH4 obtained from Step 1) are mixed with LiOH and ZrO₂ powders to obtain a first mixture. TMH3 and TMH4 powders are mixed in a 7:3 ratio by weight, the lithium to metal molar ratio is 1.03, and the Zr content in the mixture is 3700 ppm.

Step 3) First firing: The first mixture from Step 2) is fired at 870° C. for 12 hours in an oxidizing atmosphere so as to obtain a first fired powder labelled as CEX4.1.

CEX4.2 is prepared according to the following process:

Step 1) CEX4.1 is mixed with WO₃ powder to obtain a mixture contains about 0.45 wt. % of tungsten with respect to the total weight of the mixture.

Step 2) Heating the mixture obtained from Step 1) in a furnace under the flow of an oxidizing atmosphere at 400° C. for 7 hours.

Step 3) Crushing and sieving the heated product from Step 2) so as to obtain a powder labelled as CEX4.2.

### Comparative Example 5

A single-crystalline positive electrode active material labelled as CEX5 is prepared according to the following steps:

Step 1) Transition metal oxidized hydroxide precursor preparation: A nickel-based transition metal oxidized hydroxide powder (TMH5) having a metal composition of Ni_{0.68}Mn_{0.2}0Co_{0.12} is prepared by a co-precipitation process in a large-scale continuous stirred tank reactor (CSTR) with mixed nickel manganese cobalt sulfates, sodium hydroxide, and ammonia.

Step 2) First mixing: TMH5 prepared from Step 1) is mixed with LiOH in an industrial blender so as to obtain a first mixture having a lithium to metal ratio of 0.97.

Step 4) First firing: The first mixture from Step 2) is fired at 920° C. for 10 hours in an oxidizing atmosphere so as to obtain a first fired powder.

Step 5) Jet milling: The first fired powder from Step 4) is jet milled to obtain a milled powder labelled as CEX5.

### Example 2

A single-crystalline positive electrode active material labelled as EX2 is prepared according to the following steps:

Step 1) CEX5 is mixed with WO₃ powder to obtain a mixture contains about 0.45 wt. % of tungsten with respect to the total weight of the mixture.

Step 2) Heating the mixture obtained from Step 1) in a furnace under the flow of an oxidizing atmosphere at 350° C. for 10 hours.

Step 3) Crushing and sieving the heated product from Step 2) so as to obtain a powder labelled as EX2.

### Comparative Example 6

A polycrystalline positive electrode active material labelled as CEX6.1 is prepared according to the following steps:

Step 1) Transition metal oxidized hydroxide precursor preparation: A nickel-based transition metal oxidized hydroxide powder (TMH6) having a metal composition of Ni_{0.80}Mn_{0.10}Co_{0.10} is prepared by a co-precipitation process in a large-scale continuous stirred tank reactor (CSTR) with mixed nickel manganese cobalt sulfates, sodium hydroxide, and ammonia.

Step 2) First heating: TMH6 prepared from Step 1) is heated at 375° C. for 7 hours in an oxidizing atmosphere to obtain a heated TMH6.

Step 3) First mixing: heated TMH6 prepared from Step 2) is mixed with LiOH in an industrial blender so as to obtain a first mixture having a lithium to metal ratio of 1.00.

Step 4) Second heating: The first mixture from Step 3) is fired at 810° C. for 12 hours in an oxidizing atmosphere followed by crushing and sieving process so as to obtain a fired powder labelled as CEX6.1.

CEX6.2 is prepared according to the following process:

Step 1) CEX6.1 is mixed with WO₃ powder to obtain a mixture contains about 0.42 wt. % of tungsten with respect to the total weight of the mixture.

Step 2) Heating the mixture obtained from Step 1) in a furnace under the flow of an oxidizing atmosphere at 285° C. for 8 hours.

Step 3) Crushing and sieving the heated product from Step 2) so as to obtain a powder labelled as CEX6.2.

The chemical compositions of the products from the examples and comparative examples counterexamples were determined by ICP-OES and are given in Table 2, expressed as a fraction compared to the total of Co, Ni, Mn and W.

Table 2 summarizes the composition of examples and comparative examples and their corresponding electrochemical properties. EX1.0 shows DQ1 improvement in comparison with CEX1.1 indicating tungsten mixing and heating application according to this invention is advantageous. Likewise, EX1.4 shows higher DQ1 in comparison with CEX2.

TABLE 2
Summary of the composition and the corresponding electrochemical
properties of example and comparative examples.

| | | | | | | W | Heating T | | DQ1 | IRRQ |
|---|---|---|---|---|---|---|---|---|---|---|
| ID | Li | Ni | Mn | Co | W* | (wt. %)** | (° C.) | Phase*** | (mAh/g) | (%) |
| CEX1.1 | 0.96 | 0.86 | 0.07 | 0.071 | 0 | 0 | — | — | 195.0 | 16.6 |
| EX1.0 | 0.96 | 0.86 | 0.07 | 0.071 | 0.002 | 0.44 | 350 | Li₂WO₄ + WO₃ | 199.0 | 15.4 |
| CEX2 | 0.97 | 0.84 | 0.07 | 0.089 | 0 | 0.00 | — | — | 198.1 | 14.3 |
| EX1.1 | 0.98 | 0.84 | 0.07 | 0.089 | 0.001 | 0.26 | 350 | Li₂WO₄ + WO₃ | 203.5 | 12.3 |
| EX1.2 | 0.98 | 0.84 | 0.07 | 0.089 | 0.002 | 0.36 | 350 | Li₂WO₄ + WO₃ | 202.8 | 12.3 |
| EX1.3 | 0.99 | 0.83 | 0.07 | 0.089 | 0.002 | 0.42 | 350 | Li₂WO₄ + WO₃ | 203.6 | 11.8 |
| EX1.4 | 0.97 | 0.84 | 0.07 | 0.089 | 0.002 | 0.44 | 350 | Li₂WO₄ + WO₃ | 206.2 | 12.2 |
| EX1.5 | 0.99 | 0.84 | 0.07 | 0.089 | 0.003 | 0.50 | 350 | Li₂WO₄ + WO₃ | 205.9 | 11.7 |
| EX1.6 | 0.98 | 0.84 | 0.07 | 0.089 | 0.004 | 0.73 | 350 | Li₂WO₄ + WO₃ | 207.4 | 11.3 |
| EX1.7 | 0.97 | 0.83 | 0.07 | 0.089 | 0.008 | 1.42 | 350 | Li₂WO₄ + WO₃ | 203.8 | 11.5 |
| EX1.8 | 0.98 | 0.84 | 0.07 | 0.089 | 0.002 | 0.36 | 300 | Li₂WO₄ + WO₃ | 202.4 | 12.7 |
| EX1.9 | 0.98 | 0.84 | 0.07 | 0.089 | 0.002 | 0.36 | 400 | Li₂WO₄ + WO₃ | 203.9 | 11.9 |
| CEX3.1 | 0.97 | 0.83 | 0.07 | 0.089 | 0.015 | 2.92 | 350 | Li₂WO₄ + WO₃ | 196.7 | 11.9 |
| CEX3.2 | 0.98 | 0.84 | 0.07 | 0.089 | 0.002 | 0.36 | — | WO₃ | 193.3 | 13.7 |
| CEX3.3 | 0.96 | 0.86 | 0.07 | 0.089 | 0 | 0.44 | 550 | — | 186.5 | 14.4 |
| CEX4.1 | 1.03 | 0.65 | 0.20 | 0.150 | 0 | 0 | — | — | 179.2 | 12.0 |
| CEX4.2 | 1.03 | 0.65 | 0.20 | 0.150 | 0.002 | 0.45 | 400 | Li₂WO₄ + WO₃ | 179.3 | 12.0 |
| CEX5 | 0.97 | 0.68 | 0.20 | 0.120 | 0 | 0 | — | — | 172.1 | 15.8 |
| EX2 | 0.97 | 0.68 | 0.20 | 0.120 | 0.002 | 0.45 | 350 | Li₂WO₄ + WO₃ | 174.9 | 14.7 |
| CEX6.1 | 1.00 | 0.80 | 0.10 | 0.100 | 0 | 0 | — | — | 196.9 | 12.6 |
| CEX6.2 | 1.00 | 0.80 | 0.10 | 0.100 | 0.002 | 0.42 | 285 | Li₂WO₄ + WO₃ | 194.2 | 13.8 |

*expressed as fraction of (Co+Ni+Mn+W)
** as determined by ICP-OES measurement, expressed as percentage compared to the total weight of the product.
*** as determined by XRD analysis
-: not applicable

EX1.1 to EX1.7 and CEX3.1 each comprises different tungsten content but with same heating temperature at 350° C. The concentration ranges from 0.26 wt. % at EX1.1 to 1.42 wt. % at EX1.7 is demonstrated to effectively achieve the objective of this invention. On the contrary, CEX3.1 comprising 2.92 wt. % tungsten decreases DQ1 to 196.7 mAh/g from bare CEX2 of 198.1 mAh/g.

EX1.8, EX1.9, CEX 3.2, and CEX3.3 show heating temperature effect to the positive electrode active material comprising tungsten source. The heating temperature from 300° C. at EX1.8 to 400° C. at EX1.9 is demonstrated to effectively achieve the objective of this invention. On the contrary, CEX3.2 with no heating and CEX3.3 with 550° C. heating shows low DQ1 of 193.3 mAh/g and 186.5 mAh/g, respectively. This result indicates heating after tungsten mixing is essential given the temperature is lower than 550° C.

CEX4.1 and CEX4.2 are positive electrode active material with polycrystalline morphology comprising 65 mol % Ni. CEX4.2 is further comprising 0.45 wt. % tungsten, however, shows no improvement of DQ1 in comparison with CEX4.1. CEX6.1 and CEX6.2 are positive electrode active material with polycrystalline morphology comprising 80 mol % Ni wherein CEX6.2 further comprising 0.42 wt. % tungsten. Similarly, there is no improvement in DQ1 for CEX6.2 in comparison with CEX6.1. It is observed that the polycrystalline morphology is not suitable to achieve the improvement in the DQ1 even with higher total Ni content in the material. On the other hand, EX2 having a single-crystalline morphology comprising 68 mol % and 0.45 wt. % tungsten shows DQ1 improvement in comparison with CEX5 comprising the same Ni amount.

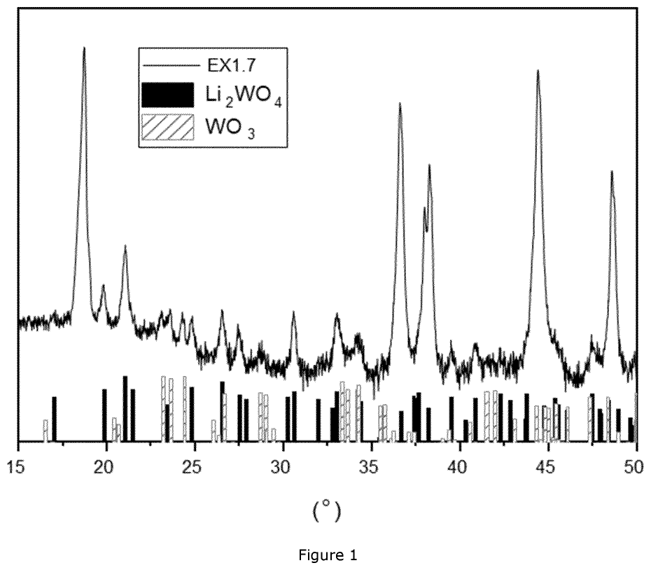

X-ray diffractometry is conducted to identify tungsten phases correspond to the heating temperature. FIG. 1 shows the XRD patterns of EX1.7 has three phases: R-3m (a third compound phase of LiNi_{0.86}Mn_{0.07}Co_{0.07}O₂ according to this invention), R-3 (a first compound phase of Li₂WO₄ according to this invention), and P21/n (a second compound phase of WO₃).

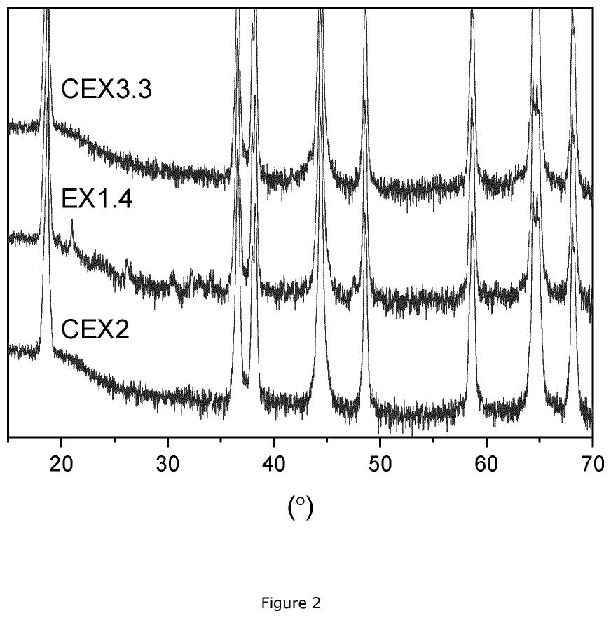

FIG. 2 shows the XRD patterns of CEX3.3, EX1.4, and CEX2. CEX2 and CEX3.3 have XRD patterns related to a R-3m phase. According to “Journal of Power Sources (2000), 90, 76-81”, the XRD patterns indicates that CEX2 and CEX3.3 are lithium transition metal oxide compounds. They have a general formula of LiNi_{0.86}Mn_{0.07}Co_{0.07}O₂. EX1.4 shows R-3m, R-3, and P21/n phases correspond to LiNi_{0.86}Mn_{0.07}Co_{0.07}O₂, Li₂WO₄, and WO₃, respectively as described in FIG. 1. This result indicates that 350° C. heating temperature is suitable to produce the first and second compound phases according to this invention. It is when the aforementioned R-3m, R-3, and P21/n phases presence in the positive electrode active material, the electrochemical properties are improved.

1-16. (canceled)

17. A positive electrode active material for lithium-ion liquid electrolyte rechargeable batteries, whereby the positive electrode active material is a powder which comprises Li, M′, and O, wherein M′ consists of:
Co in a content x superior or equal to 2.0 mol % and inferior or equal to 35.0 mol %, relative to M′,
Mn in a content y superior or equal to 0 mol % and inferior or equal to 35.0 mol %, relative to M′,
A in a content m superior or equal to 0 mol % and inferior or equal to 5 mol %, relative to M′, whereby A comprises at least one element of the group consisting of: Al, Ba, B, Mg, Nb, Sr, Ti, W, S, Ca, Cr, Zn, V, Y, Si, and Zr,
Ni in a content of 100-x-y-m mol %,
i. a first compound which comprises Li₂WO₄,
ii. and a second compound which comprises WO₃,
whereby the powder is a single-crystalline powder,
whereby the positive electrode active material comprises Li in a molar ratio of Li/(Co+Mn+Ni+A) of at least 0.900 and at most 1.100.

18. Positive electrode active material according to claim 17, whereby the positive electrode active material comprises a third compound which has a crystal structure which belongs to the R-3m space group.

19. Positive electrode active material according to claim 17, whereby the positive electrode active material comprises a third compound which is a Li-M′-oxide.

20. Positive electrode active material according to claim 17, whereby said first compound has a crystal structure which belongs to the R-3 space group, and whereby said second compound has a crystal structure which belongs to the P21/n space group, as determined by X-Ray diffraction analysis.

21. Positive electrode active material according to claim 17, wherein the total content of tungsten is between 0.20 wt. % and 2.50 wt. % with respect to the total weight of said positive electrode active material, as determined by ICP-OES analysis.

22. Positive electrode active material according to claim 17, wherein the total content of tungsten is between 0.30 wt. % and 2.00 wt. % with respect to the total weight of said positive electrode active material, as determined by ICP-OES analysis.

23. Positive electrode active material according to claim 17, wherein the positive electrode active material has a median particle size D50 of between 2 μm and 7 μm, as determined by laser diffraction particle size analysis.

24. Positive electrode active material according to claim 17, whereby the positive electrode active material size D99 is at least 5 m and at most 25 m, as determined by laser diffraction particle size analysis.

25. Positive electrode active material according to claim 17, wherein the positive electrode active material size D99 is at least 7 m and at most 20 m, as determined by laser diffraction particle size analysis.

26. Positive electrode active material according to claim 17, whereby m is inferior or equal to 2.0 mol %, relative to M′.

27. Positive electrode active material according to claim 17, whereby the first compound is Li₂WO₄.

28. Positive electrode active material according to claim 17, whereby the second compound is WO₃.

29. Positive electrode active material according to claim 17, wherein Ni content 100-x-y-m is between 60 mol % to 95 mol %, relative to M′.

30. A lithium-ion rechargeable battery comprising a positive electrode active material according to claim 17.

31. Battery cell comprising a positive electrode active material according to claim 17.

32. A portable computer, a tablet, a mobile phone, an electrically powered vehicle, or an energy storage system comprising the positive electrode active material according to claim 17.
